(19) United States
(12) Patent Application Publication
(10) Pub. No.: US 2020/0173524 A1
(43) Pub. Date: Jun. 4, 2020

(54) CONTINUOUSLY VARIABLE TRANSMISSION AND METHOD FOR MANUFACTURING THE SAME

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Kazumichi TSUKUDA, Okazaki (JP); Kenta YAMADA, Nagoya (JP); Kosuke KIKUCHI, Anjo (JP); Jun HAKAMAGI, Toyota (JP); Norikazu AKAMATSU, Nisshin (JP); Shinya KUWABARA, Toyota (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 16/637,940

(22) PCT Filed: Aug. 28, 2018
(86) PCT No.: PCT/JP2018/031721

§ 371 Date: Feb. 10, 2020

(30) Foreign Application Priority Data
Sep. 28, 2017 (JP) 2017-188466
Sep. 28, 2017 (JP) 2017-188604

(51) Int. Cl. F16H 9/20; F16H 55/56; F16H 57/04; B21J 5/06; B21J 1/02; B21J 1/06; B21D 53/26; B21D 53/88; B21K 1/12

(52) U.S. Cl. CPC F16H 9/20; F16H 55/56; F16H 57/0489; B21J 5/06; B21K 1/12; B21J 1/06; B21D 53/26; B21D 53/88; B21J 1/02

(57) ABSTRACT

A continuously variable transmission includes: a first pulley having a first fixed sheave and a first movable sheave; a first cylinder forming a first oil chamber with the first movable sheave; a second pulley having a second fixed sheave and a second movable sheave; a second cylinder forming a second oil chamber with the second movable sheave; and a transmission belt wound around the first pulley and the second pulley. The first cylinder has a first member that is fixed to a first shaft and a second member that is joined to an outer peripheral portion of the first member. A bearing is interposed between an outer periphery of the first member and an inner periphery of a case. A thickness, in an axial direction, of a portion of the first member that is configured to directly abut against the first movable sheave is larger than a thickness of the second member.

### CROSS REFERENCE TO RELATED APPLICATIONS

This application is a National Stage of International Application No. PCT/JP2018/031721, filed Aug. 28, 2018, claiming priorities to Japanese Patent Application No. 2017-188466 and Japanese Patent Application No. 2017-188604, filed Sep. 28, 2017 respectively.

### TECHNICAL FIELD

The disclosure relates to a continuously variable transmission and a method for manufacturing the same.

### BACKGROUND ART

Conventionally, a continuously variable transmission (CVT) that has a primary pulley mounted on a transmission input shaft, a secondary pulley mounted on a transmission output shaft, and a belt wound around the primary pulley and the secondary pulley is proposed as this type of continuously variable transmission (see Patent Document 1). Here, the primary pulley has a first fixed sheave that is provided integrally with the transmission input shaft and a first movable sheave that is attached to the transmission input shaft so as to be movable in an axial direction. A first cylinder portion that forms a first hydraulic pressure chamber with the first movable sheave is provided on a rear surface side of the first movable sheave. The secondary pulley has a second fixed sheave that is provided integrally with the transmission output shaft and a second movable sheave that is attached to the transmission output shaft so as to be movable in the axial direction. A second cylinder portion that forms a second hydraulic pressure chamber with the second movable sheave is provided on a rear surface side of the second movable sheave. In the continuously variable transmission, the second cylinder portion is fixed in the axial direction of the transmission output shaft by a nut that is screwed to a screw portion formed on an end portion of the transmission output shaft, and a step portion that is formed on the transmission output shaft. The second cylinder portion is supported by a case via a bearing so as to be rotatable.

### RELATED ART DOCUMENTS

### Patent Documents

Patent Document 1: Japanese Unexamined Patent Application Publication No. 2015-183753 (JP 2015-183753 A)

### SUMMARY OF THE DISCLOSURE

In the continuously variable transmission, the thickness (plate thickness) of the second cylinder portion is generally constant and the rigidity (strength) is not so high, since the second cylinder portion is formed as a single member by press working, for example. Thus, when the second movable sheave abuts against the second cylinder portion, a portion of the second cylinder portion that is subjected to force from the second movable sheave is pressed to the nut side and the portion may be deformed. In response to this, increasing the thickness of the second cylinder portion so as to increase the rigidity of the second cylinder portion can also be considered. However, if the thickness of the entire second cylinder portion is not increased, the second cylinder portion cannot be formed by press working, and if the thickness of the entire second cylinder portion is increased, the weight of the second cylinder portion is increased, which leads to the weight of the continuously variable transmission being increased.

It is an aspect of a continuously variable transmission and a manufacturing method of the same of the disclosure to increase the rigidity of a portion of a cylinder that is subject to a force from a movable sheave while suppressing the weight of the continuously variable transmission from increasing.

The continuously variable transmission and the manufacturing method of the same of the disclosure adopt the following means for achieving the aspect described above.

The continuously variable transmission of the disclosure is a continuously variable transmission including:
a first pulley having a first fixed sheave that is formed integrally with a first shaft or is fixed to the first shaft and a first movable sheave that is supported by the first shaft so as to be slidable in an axial direction of the first shaft;
a first cylinder that forms a first oil chamber with the first movable sheave;
a second pulley having a second fixed sheave that is formed integrally with a second shaft or is fixed to the second shaft and a second movable sheave that is supported by the second shaft so as to be slidable in the axial direction of the second shaft;
a second cylinder that forms a second oil chamber with the second movable sheave; and
a transmission belt that is wound around the first pulley and the second pulley, in which
the first cylinder has a first member that is fixed to the first shaft and a second member that is joined to an outer peripheral portion of the first member,
a bearing is interposed between an outer periphery of the first member and an inner periphery of a case, and
a thickness of a portion of the first member that is configured to directly abut against the first movable sheave is larger than a thickness of the second member.

In the continuously variable transmission of the disclosure, the first cylinder has the first member that is fixed to the first shaft and the second member that is joined to the outer peripheral portion of the first member. The bearing is interposed between the outer periphery of the first member and the inner periphery of the case. In this way, it is possible to shorten the axial length of the first shaft, compared to when the bearing is interposed between the outer periphery of the first shaft and the inner periphery of the case, on the opposite side of the first member from the first movable sheave in the axial direction of the first shaft. The thickness, in the axial direction, of the portion of the first member that is configured to directly abut against the first movable sheave is larger than the thickness of the second member. In this way, compared to when the first cylinder is formed of a single member, it is possible to easily increase the thickness, in the axial direction, of the portion of the first member that is configured to directly abut against the first movable sheave (the portion that is subject to a force from the first movable sheave). Thus, the rigidity of the portion can be increased. It is possible to decrease the thickness (plate thickness) of a portion in which there is not much need to increase the rigidity, such as the second member. It is thus possible to suppress the weight of the second member, the first cylinder, and the continuously variable transmission from increasing. That is, it is possible to increase the rigidity of the portion of the first member of the first cylinder that is subject to the force from the first movable sheave, while suppressing the weight of the continuously variable transmission from increasing. It is possible to shorten the axial length of the first shaft by making the first member directly abuttable against the first movable sheave, compared to when a washer or a sheet member is provided between the first member and the first movable sheave.

A manufacturing method of a continuously variable transmission of the disclosure is a manufacturing method of a continuously variable transmission including:
a first pulley having a first fixed sheave that is formed integrally with a first shaft or is fixed to the first shaft and a first movable sheave that is supported by the first shaft so as to be slidable in an axial direction of the first shaft;
a first cylinder that forms a first oil chamber with the first movable sheave;
a second pulley that has a second fixed sheave formed integrally with a second shaft or fixed to the second shaft and a second movable sheave that is supported by the second shaft so as to be slidable in the axial direction of the second shaft;
a second cylinder that forms a second oil chamber with the second movable sheave; and
a transmission belt that is wound around the first pulley and the second pulley, in which
the first cylinder has a first member that is fixed to the first shaft and a second member that is joined to an outer peripheral portion of the first member,
a bearing is interposed between an outer periphery of the first member and an inner periphery of a case, and
the manufacturing method including:
a step (a) of forming the first member by a step at least including hot-forging, carburizing processing, quenching processing, and tempering processing, and forming the second member by press working so that a thickness of the second member is smaller than a thickness of a portion of the first member that is configured to directly abut against the first movable sheave;
a step (b) of performing cutting to remove a carburized layer so that a portion of the first member that is to be joined to the second member is exposed, after the step (a); and
a step (c) of joining the second member to the portion of the first member that is to be joined, after the step (b).

In the continuously variable transmission of the disclosure, the first cylinder has the first member that is fixed to the first shaft and the second member that is joined to the outer peripheral portion of the first member. The bearing is interposed between the outer periphery of the first member and the inner periphery of the case. In this way, it is possible to shorten the axial length of the first shaft, compared to when the bearing is interposed between the outer periphery of the first shaft and the inner periphery of the case, on the opposite side of the first member from the first movable sheave in the axial direction of the first shaft. In the manufacturing method of the continuously variable transmission of the disclosure, the first member is formed by the step at least including hot-forging, carburizing processing, quenching processing, and tempering processing, and the second member is formed by press working so that the thickness of the second member is smaller than the thickness of the portion of the first member that is configured to directly abut against the first movable sheave. Cutting is then performed to remove the carburized layer so that the portion of the first member that is to be joined to the second member is exposed. The second member is joined to the portion of the first member that is to be joined. Since cutting is performed to remove the carburized layer so that the portion of the first member that is to be joined to the second member is exposed before joining the second member to the portion of the first member that is to be joined, it is possible to easily join the first member and the second member, compared to when the cutting is not performed. In the continuously variable transmission manufactured in this way, the first cylinder is configured of the first member and the second member. Compared to when the first cylinder is configured of a single member, it is possible to increase the thickness, in the axial direction, of the portion of the first member that is configured to directly abut against the first movable sheave (the portion that is subject to a force from the first movable sheave). Thus, the rigidity of the portion can be increased. It is possible to decrease the thickness (plate thickness) of a portion in which there is not much need to increase the rigidity, such as the second member. It is thus possible to suppress the weight of the second member, the first cylinder, and the continuously variable transmission from increasing. That is, it is possible to increase the rigidity of the portion of the first member of the first cylinder that is subject to the force from the first movable sheave, while suppressing the weight of the continuously variable transmission from increasing. It is possible to shorten the axial length of the first shaft by making the first member directly abuttable against the first movable sheave, compared to when a washer or a sheet member is provided between the first member and the first movable sheave.

### BRIEF DESCRIPTION OF THE DRAWINGS

FIG. 1 is a schematic configuration diagram of a continuously variable transmission 10 of the disclosure.

FIG. 2 is an enlarged view of a main portion of the continuously variable transmission 10.

FIG. 3 is a process chart of a manufacturing process of a primary cylinder 30.

### DETAILED DESCRIPTION

Modes for carrying out the various aspects of the disclosure will be described with reference to the drawings.

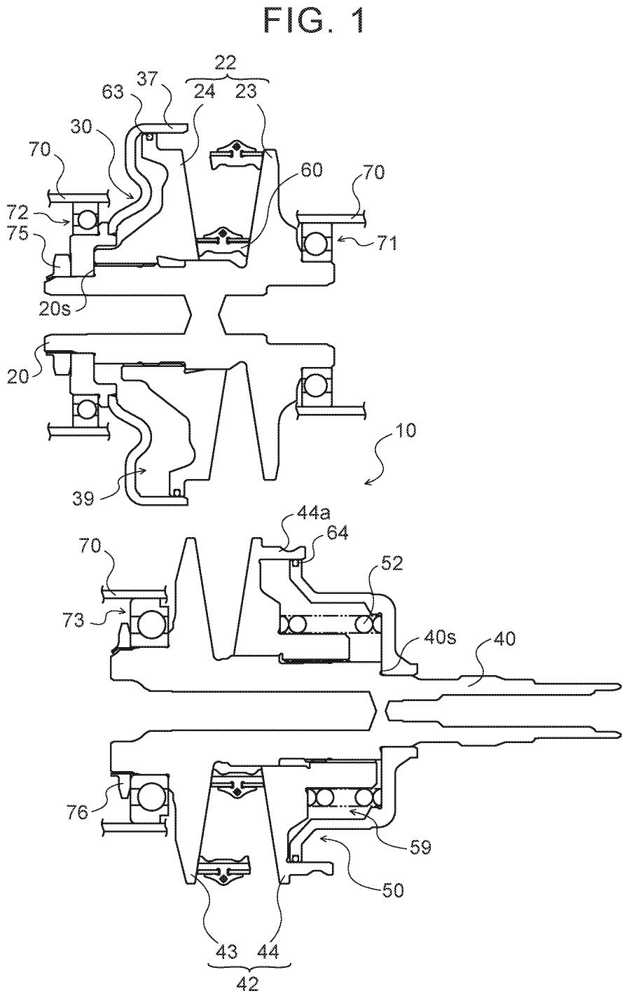

FIG. 1 is a schematic configuration diagram of a continuously variable transmission (CVT) 10 of the disclosure. The continuously variable transmission 10 is installed in a vehicle, and as illustrated in the figure, includes: a primary shaft (first shaft) 20 that serves as a driving rotary shaft; a primary pulley (first pulley) 22 that rotates integrally with the primary shaft 20; a primary cylinder (first cylinder) 30 that is a hydraulic actuator for changing a groove width of the primary pulley 22; a secondary shaft (first shaft) 40 that serves as a driven rotary shaft that is disposed in parallel with the primary shaft 20; a secondary pulley (second pulley) 42 that rotates integrally with the secondary shaft 40; a secondary cylinder (second cylinder) 50 that is a hydraulic actuator for changing a groove width of the secondary pulley 42; and a transmission belt 60 that is wound around a pulley groove (V-shaped groove) of the primary pulley 22 and a pulley groove (V-shaped groove) of the secondary pulley 42. The primary shaft 20 is coupled to an input shaft via a forward/reverse travel switching mechanism etc., the input shaft being coupled to a power source such as an engine. The secondary shaft 40 is coupled to driving wheels of the vehicle via a gear mechanism, a differential gear, and a drive shaft. The continuously variable transmission 10 changes the groove width of the primary pulley 22 and the groove width of the secondary pulley 42 so as to change, in a stepless manner, the speed of a torque transmitted to the primary shaft 20 and to output the torque to the secondary shaft 40.

The primary pulley 22 has a primary fixed sheave (first fixed sheave) 23 that is formed integrally with the primary shaft 20 or is fixed to the primary shaft 20, and a primary movable sheave (first movable sheave) 24 that is supported by the primary shaft 20 via a spline etc. so as to be slidable in an axial direction. The primary cylinder 30 is disposed behind of the primary movable sheave 24 and forms a first oil chamber 39 with the primary movable sheave 24. A seal mounting groove is formed on an outer peripheral surface of the primary movable sheave 24. The primary cylinder 30 has a cylindrical portion 37 that has a cylindrical shape and that extends in the axial direction of the primary shaft 20. In the seal mounting groove of the primary movable sheave 24, a sealing member 63 such as a seal ring is disposed so as to be in sliding contact with an inner peripheral surface of the cylindrical portion 37 of the primary cylinder 30. The primary cylinder 30 is press fitted from a left end side of the primary shaft 20 in FIG. 1 and is fixed to the primary shaft 20 with a step portion 20s that is formed on the primary shaft 20 and a nut (fixing member) 75 that is screwed to a screw portion formed on a left end portion of the primary shaft 20 in FIG. 1.

A right end portion of the primary shaft 20 in FIG. 1 is supported by a bearing 71 interposed between the primary shaft 20 and a case 70 that houses the CVT 10 so as to be rotatable with respect to the case 70. The left end portion of the primary shaft 20 in FIG. 1 is supported by a bearing 72 interposed between the primary cylinder 30 that is fixed to the primary shaft 20 and the case 70 so as to be rotatable with respect to the case 70.

The secondary pulley 42 has a secondary fixed sheave (second fixed sheave) 43 that is formed integrally with the secondary shaft 40 or is fixed to the secondary shaft 40, and a secondary movable sheave (second movable sheave) 44 that is supported by the secondary shaft 40 via a spline etc. so as to be slidable in the axial direction and that is urged in the axial direction by a return spring 52. The secondary cylinder 50 is disposed behind the secondary movable sheave 44 and forms a second oil chamber 59 with the secondary movable sheave 44. A seal mounting groove is formed on an outer peripheral surface of the secondary cylinder 50. The secondary movable sheave 44 has a cylindrical portion 44a that has a cylindrical shape and that extends in the axial direction of the secondary shaft 40. In the seal mounting groove of the secondary cylinder 50, a sealing member 64 such as a seal ring is disposed so as to be in sliding contact with an inner peripheral surface of the cylindrical portion 44a of the secondary movable sheave 44. The secondary cylinder 50 is press fitted from a right end side of the secondary shaft 40 in FIG. 1 and is fixed to the secondary shaft 40 with a step portion 40s that is formed on the secondary shaft 40 and a nut (fixing member, not shown) that is screwed to a screw portion formed on the secondary shaft 40.

A left end portion of the secondary shaft 40 in FIG. 1 is supported by a bearing 73 interposed between the secondary shaft 40 and the case 70 so as to be rotatable with respect to the case 70. A right end portion of the secondary shaft 40 in FIG. 1 is supported by a bearing (not shown) interposed between the secondary shaft 40 and the case 70 so as to be rotatable with respect to the case 70. The bearing 73 is fixed to the secondary shaft 40 with the secondary fixed sheave 43 and a nut (fixing member) 76 that is screwed to a screw portion formed on the left end portion of the secondary shaft 40 in FIG. 1.

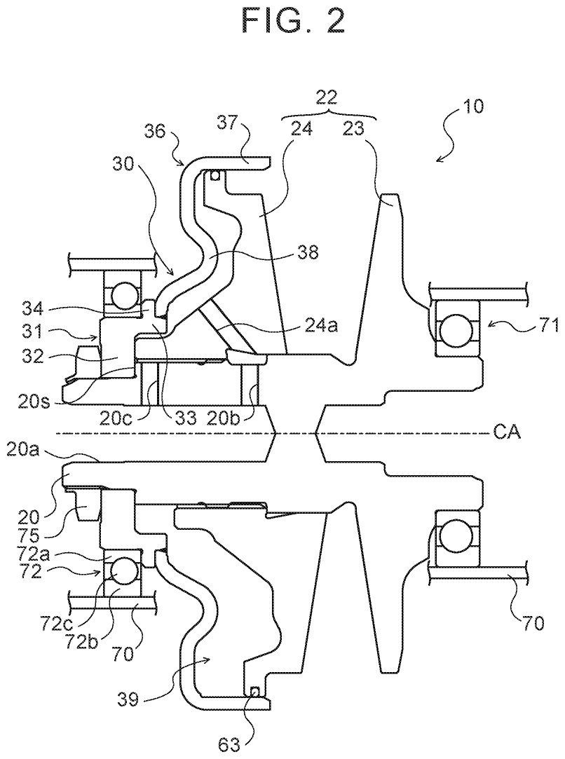

FIG. 2 is an enlarged view of a main portion of the continuously variable transmission 10. As illustrated in FIG. 2, an oil passage 20a that extends in the axial direction of the primary shaft 20 and oil passages 20b, 20c that extend radially outward from the oil passage 20a so as to open to an outer peripheral surface of the primary shaft 20 are formed on the primary shaft 20. An oil passage 24a that allows communication between the oil passage 20b and the first oil chamber 39 is formed in the primary movable sheave 24. When the groove width of the primary pulley 22 is wide (a state of the primary pulley 22 above the primary shaft 20 in FIG. 2), the oil passage 20a and the first oil chamber 39 are in communication with each other via the oil passages 20b, 24a. When the groove width of the primary pulley 22 is narrow (a state of the primary pulley 22 below the primary shaft 20 in FIG. 2), the oil passage 20a and the first oil chamber 39 are in communication with each other via the oil passage 20c.

The primary cylinder 30 has a first member 31 that is fixed to the primary shaft 20 with the step portion 20s of the primary shaft 20 and the nut 75, and a second member 36 that is joined to the first member 31 and that has the cylindrical portion 37 described above. The first member 31 is formed to have a bottomed cylindrical shape. The first member 31 has an annular side wall portion 32, a cylindrical portion 33 that has a cylindrical shape and that extends from an outer periphery of the side wall portion 32 toward the primary movable sheave 24 side (right side in FIG. 2) in the axial direction of the primary shaft 20, and a flange portion 34 that extends from a portion of the cylindrical portion 33 on the side wall portion 32 side toward the radially outer side of an open end.

The first member 31 is a hot-forged member and a carburized member that is formed so that a thickness of the side wall portion 32 in the axial direction of the primary shaft 20 (left-right direction in FIG. 2) is larger than a thickness of the second member 36, by performing molding through hot-forging, carburizing processing, quenching processing, and tempering processing on a metal blank such as chromium steel material (SCr material). In the first member 31, cutting (polishing) is performed on an inner peripheral surface and an outer peripheral surface of the side wall portion 32, an end face on the primary movable sheave 24 side (right side in FIG. 2), an end face on the nut 75 side (left side in FIG. 2), an outer peripheral surface of the cylindrical portion 33, and an end face on the opposite side of the flange portion 34 from the side wall portion 32 (right side in FIG. 2). The continuously variable transmission 10 of the disclosure is designed so that the end face of the primary movable sheave 24 on the nut 75 side directly abuts against the end face of the side wall portion 32 of the first member 31 on the primary movable sheave 24 side, when the groove width of the primary pulley 22 is the largest (when the primary movable sheave 24 is positioned on the leftmost side in FIG. 2).

The second member 36 has an annular side wall portion 38 that extends radially inward from an end portion on the opposite side of an open end of the cylindrical portion 37 (left side in FIG. 2), besides the cylindrical portion 37 described above. The second member 36 is a press molded member that is formed by performing molding by press working on a metal blank such as iron. In the second member 36, the inner peripheral surface of the cylindrical portion 37 is cut (polished). The first member 31 and the second member 36 are joined (fixed) by causing a left end face of the second member 36 in FIG. 2 to abut against a right end face of the flange portion 34 of the first member 31 in FIG. 2, and by welding an outer peripheral surface of a portion on the open end side of the cylindrical portion 33 of the first member 31 relative to the flange portion 34 (and a right end face of the flange portion 34 in FIG. 2) and an inner peripheral surface of the side wall portion 38 of the second member 36 (and a left end face of an inner peripheral portion of the side wall portion 38 in FIG. 2). Before joining the first member 31 and the second member 36, a carburized layer is removed from a portion of the first member 31 to which the second member 36 is joined, so that a non-carburized layer is exposed.

In this way, the first member 31 is formed so that the thickness of the side wall portion 32 (portion subject to a force from the primary movable sheave 24) of the first member 31 in the axial direction of the primary shaft 20 (left-right direction in FIG. 2) is more than the thickness of the second member 36. It is thus possible to easily increase the thickness of the side wall portion 32 in the axial direction of the primary shaft 20 compared to when the primary cylinder 30 is configured of a single member. The rigidity of the side wall portion 32 can therefore be increased. In this way, by increasing the rigidity of the side wall portion 32 of the first member 31, it is possible to suppress deformation of the first member 31 resulting from a force from the primary movable sheave 24 and the nut 75 that acts on the side wall portion 32 of the first member 31. It is possible to decrease the thickness (plate thickness) of a portion in which there is not much need to increase the rigidity, such as the second member 36. It is also possible to suppress the weight of the second member 36, the primary cylinder 30, and the continuously variable transmission 10 from increasing. It is thus possible to increase the rigidity of the side wall portion 32 of the first member 31 of the primary cylinder 30 (a portion that is subjected to a force from the primary movable sheave 24 and the nut 75) while suppressing the weight of the continuously variable transmission 10 from increasing.

Since the first member 31 is a carburized member (a carburized layer is formed on at least a surface of the side wall portion 32 that abuts against the primary movable sheave 24), it is possible to further increase the surface hardness of the surface of the side wall portion 32 of the first member 31 that abuts against the primary movable sheave 24, compared to a case when the first member 31 is not a carburized member (a carburized layer is not formed on the surface of the side wall portion 32 that abuts against the primary movable sheave 24). In this way, it is possible to improve (ensure) durability of the first member 31 against contact surface pressure that acts on the first member 31 from the primary movable sheave 24, without providing a washer or a sheet member between the first member 31 and the primary movable sheave 24. It is possible to shorten the axial length of the primary shaft 20 by not providing a washer or a sheet member between the first member 31 and the primary movable sheave 24. That is, it is possible to improve durability of the first member 31 against contact surface pressure that acts on the first member 31 from the primary movable sheave 24 (resolve inconveniences resulting from contact surface pressure) while shortening the axial length of the primary shaft 20. It is also possible to reduce the amount of carburized members compared to when the primary cylinder 30 is configured of a single member and the entire primary cylinder 30 (the first member 31 and the second member 36) is a carburized member.

It is possible to easily form the first member 31 and the second member 36 by forming with hot-forging, the first member 31 having a portion (side wall portion 32) with a relatively large thickness in the first member 31, and forming with press working, the second member 36 in which the entire thickness is relatively small.

The bearing 72 is interposed between an outer periphery of the side wall portion 32 of the first member 31 of the primary cylinder 30 (and a portion of the cylindrical portion 33 that is on the side wall portion 32 side relative to the flange portion 34) and an inner periphery of the case 70. The bearing 72 has an inner race 72a that is fitted to the outer periphery of the side wall portion 32, an outer race 72b that is fitted to the inner periphery of the case 70, a plurality of rolling elements 72c that roll between an inner ring raceway of the inner race 72a and an outer ring raceway of the outer race 72b, and a cage (not shown) that holds the rolling elements 72c. The bearing 72 is press fitted from a left side of the side wall portion 32 in FIG. 2 to an outer peripheral side of the side wall portion 32 and a right end face of the bearing 72 abuts against a left end face of the flange portion 34 of the first member 31 in FIG. 2. It is possible to shorten the axial length of the primary shaft 20 by interposing the bearing 72 between the outer periphery of the side wall portion 32 and the inner periphery of the case 70, compared to when the bearing 72 is interposed between the outer periphery of the primary shaft 20 and the inner periphery of the case 70, which is between the side wall portion 32 and the nut 75 in the axial direction of the primary shaft 20. An outer diameter of the inner race 72a of the bearing 72 (distance between the outer periphery of the inner race 72a and a shaft center CA) is longer than the shaft center CA of the primary shaft 20 and the joining portion of the first member 31 and the second member 36. When hydraulic pressure (working oil) is supplied to the first oil chamber 39, a force in the axial direction of the primary shaft 20 that results from the hydraulic pressure and acts on the second member 36 can be received by the inner race 72a, besides the second member 36 and the first member 31 (flange portion 34). As a result, it is possible to suppress deformation of the primary cylinder 30 and ensure the strength of the primary cylinder 30.

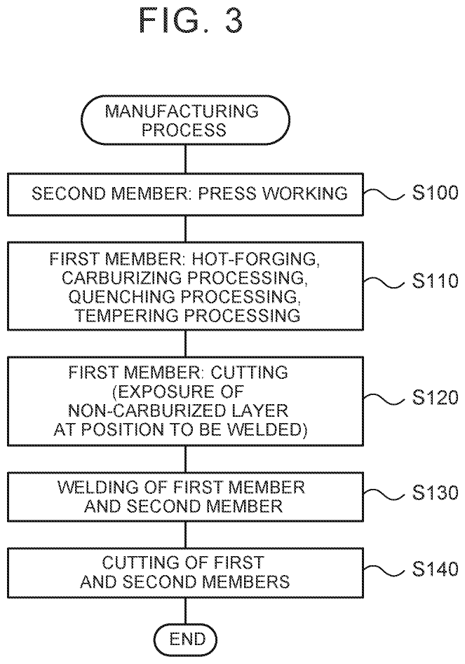

A manufacturing method of the continuously variable transmission 10, especially a manufacturing method of the primary cylinder 30 in the continuously variable transmission 10 will be described. FIG. 3 is a process chart of the manufacturing process of the primary cylinder 30. When manufacturing the primary cylinder 30, molding by press working is first performed on a metal blank such as iron to form the second member 36 as a press molded member (step S100). Molding by hot-forging, carburizing processing, quenching processing, and tempering processing are performed on a metal blank such as chromium steel material to form the first member 31 as a hot-forged member and a carburized member (step S110).

Cutting (polishing) is then performed, in which the carburized layer is removed (the non-carburized layer is exposed) so that the outer peripheral surface of a portion of the cylindrical portion 33 of the first member 31 that is on the open end side relative to the flange portion 34 (and the right end face of the flange portion 34 in FIG. 2), that is, a portion of the first member 31 that is to be joined with the second member 36 is exposed (step S120). The second member 36 is then joined (fixed) to the portion to be joined by welding (step S130). Step S120 is a step that is performed in order to make it easy to join the first member 31 and the second member 36, in consideration of the difficulty of joining the carburized layer of the first member 31 and the second member 36. That is, by performing cutting in which the carburized layer is removed so as to expose the portion of the first member 31 that is to be joined, before the portion of the first member 31 to be joined is joined to the second member 36 by welding, it is possible to easily join the first member and the second member.

Portions of the first member 31 (the inner peripheral surface and the outer peripheral surface of the side wall portion 32, the end face on the primary movable sheave 24 side, and the end face on the nut 75 side) besides the portion that is joined to the second member 36 (the portion to be joined that is described above) are cut (polished) and the inner peripheral surface of the cylindrical portion 37 of the second member 36 is cut (polished) (step S140) and manufacturing of the primary cylinder 30 is completed. After the primary cylinder 30 is manufactured in this way, the primary cylinder 30 is press fitted to the primary shaft 20 from the left side of the primary shaft 20 in FIGS. 1 and 2, and the primary cylinder 30 is fixed to the primary shaft 20 with the nut 75. It is possible to suppress variation in the inner diameter, the outer diameter, and the thickness of the side wall portion 32 of the first member 31 and suppress variation in the distance between the inner peripheral surface of the cylindrical portion 37 (a sliding contact surface on which the sealing member 63 disposed on the outer periphery of the primary movable sheave 24 is in sliding contact) and the shaft center of the primary shaft 20. Here, the distance is at positions on cylindrical portion 37 of the second member 36 along the circumferential direction. These variations result from the first member 31 and the second member 36 being joined together. Suppressing of these variations is made possible by performing step S140 after the first member 31 and the second member 36 are joined by welding.

In the continuously variable transmission 10 of the embodiment described above, the first member 31 is a carburized member. However, the continuously variable transmission 10 is not limited to this, and may be a continuously variable transmission 10 in which a carburized layer is formed on at least the surface of the side wall portion 32 that abuts against the primary movable sheave 24. The first member 31 may be a first member 31 that is not a carburized member. Although in the portion of the first member 31 that is joined to the second member 36 (the portion to be joined), the non-carburized layer is exposed, the portion to be joined may be a portion to be joined in which the non-carburized layer is not exposed.

In the continuously variable transmission 10 of the embodiment described above, the first member 31 is a hot-forged member and the second member 36 is press molded member. However, the first member 31 and the second member 36 are not limited to this, and both the first member 31 and the second member 36 may be press molded members.

In the continuously variable transmission 10 of the embodiment described above, the first member 31 of the primary cylinder 30 is fixed to the primary shaft 20 with the step portion 20s of the primary shaft 20 and the nut 75. However, the first member 31 is not limited to this, and the first member 31 may be fixed to the primary shaft 20 by joining that is performed by welding.

In the continuously variable transmission 10 of the embodiment described above, the various aspects of the disclosure is applied to the primary cylinder 30. However, these aspects of the disclosure may be applied to the secondary cylinder 50.

As described above, the continuously variable transmission of the disclosure is a continuously variable transmission (10) including: a first pulley (22) having a first fixed sheave (23) that is formed integrally with a first shaft (20) or is fixed to the first shaft (20) and a first movable sheave (24) that is supported by the first shaft (20) so as to be slidable in an axial direction of the first shaft (20); a first cylinder (30) that forms a first oil chamber with the first movable sheave (24); a second pulley (42) having a second fixed sheave (43) that is formed integrally with a second shaft (40) or is fixed to the second shaft (40) and a second movable sheave (44) that is supported by the second shaft (40) so as to be slidable in the axial direction of the second shaft (40); a second cylinder (50) that forms a second oil chamber with the second movable sheave (44); and a transmission belt (60) that is wound around the first pulley (22) and the second pulley (42). The first cylinder (30) has a first member (31) that is fixed to the first shaft (20) and a second member (36) that is joined to an outer peripheral portion of the first member (31). A bearing (72) is interposed between an outer periphery of the first member (31) and an inner periphery of a case (70). A thickness of a portion of the first member (31) that is configured to directly abut against the first movable sheave (24) is larger than a thickness of the second member (36).

In the continuously variable transmission of the disclosure, the first cylinder has the first member that is fixed to the first shaft and the second member that is joined to the outer peripheral portion of the first member. The bearing is interposed between the outer periphery of the first member and the inner periphery of the case. In this way, it is possible to shorten the axial length of the first shaft, compared to when the bearing is interposed between the outer periphery of the first shaft and the inner periphery of the case, on the opposite side of the first member from the first movable sheave in the axial direction of the first shaft. The thickness, in the axial direction, of the portion of the first member that is configured to directly abut against the first movable sheave is larger than the thickness of the second member. In this way, compared to when the first cylinder is formed of a single member, it is possible to easily increase the thickness, in the axial direction, of the portion of the first member that is configured to directly abut against the first movable sheave (the portion that is subject to a force from the first movable sheave). Thus, the rigidity of the portion can be increased. It is possible to decrease the thickness (plate thickness) of a portion in which there is not much need to increase the rigidity, such as the second member. It is thus possible to suppress the weight of the second member, the first cylinder, and the continuously variable transmission from increasing. That is, it is possible to increase the rigidity of the portion of the first member of the first cylinder that is subject to the force from the first movable sheave, while suppressing the weight of the continuously variable transmission from increasing. It is possible to shorten the axial length of the first shaft by making the first member directly abuttable against the first movable sheave, compared to when a washer or a sheet member is provided between the first member and the first movable sheave.

In the continuously variable transmission of the disclosure, the first member (31) may be a hot-forged member and the second member (36) may be a press molded member. In this way, it is possible to easily mold the first member with a portion having a relatively large thickness and the second member in which the entire thickness is relatively small.

In the continuously variable transmission of the disclosure, a carburized layer may be formed on at least a surface of the first member (31) that abuts against the first movable sheave (24). In this way, it is possible to increase a surface hardness of the surface of the first member that abuts against the first movable sheave. In this case, the carburized layer does not have to be formed on a portion of the first member (31) that is joined to the second member (36). It is thus possible to join the first member and the second member more easily.

In the continuously variable transmission of the disclosure, a protruding portion (34) that protrudes radially outward may be formed on the outer periphery of the first member (31), the second member (36) may abut against an end face of the protruding portion (34) in the axial direction, and the bearing (72) may abut against the other end face of the protruding portion (34) in the axial direction. In this case, an outer diameter of an inner race (72a) of the bearing (72) may be longer than a distance between a shaft center of the first shaft (20) and a joining portion of the first member (31) and the second member (36). In this way, it is possible to suppress deformation of the first cylinder and ensure the strength of the first cylinder, since the inner race of the bearing, besides the second member and the first member (protruding portion), can also receive a force in the axial direction of the first shaft that acts on the second member due to the hydraulic pressure in the first oil chamber.

In the continuously variable transmission, the first member (31) is fixed to the first shaft (20) with a fixing member (75) from an opposite side of the first movable sheave (24) in the axial direction of the first shaft (20).

A manufacturing method of a continuously variable transmission of the disclosure is a manufacturing method of a continuously variable transmission (10) including: a first pulley (22) having a first fixed sheave (23) that is formed integrally with a first shaft (20) or is fixed to the first shaft (20) and a first movable sheave (24) that is supported by the first shaft (20) so as to be slidable in an axial direction of the first shaft (20); a first cylinder (30) that forms a first oil chamber with the first movable sheave (24); a second pulley (42) that has a second fixed sheave (43) formed integrally with a second shaft (40) or fixed to the second shaft (40) and a second movable sheave (44) that is supported by the second shaft (40) so as to be slidable in the axial direction of the second shaft (40); a second cylinder (50) that forms a second oil chamber with the second movable sheave (44); and a transmission belt (60) that is wound around the first pulley (22) and the second pulley (42). The first cylinder (30) has a first member (31) that is fixed to the first shaft (20) and a second member (36) that is joined to an outer peripheral portion of the first member (31). A bearing (72) is interposed between an outer periphery of the first member (31) and an inner periphery of a case (70). The manufacturing method includes: a step (a) of forming the first member (31) by a step at least including hot-forging, carburizing processing, quenching processing, and tempering processing, and forming the second member (36) by press working so that a thickness of the second member (36) is smaller than a thickness of a portion of the first member (31) that is configured to directly abut against the first movable sheave (24); a step (b) of performing cutting to remove a carburized layer so that a portion of the first member (31) that is to be joined to the second member (36) is exposed, after the step (a); and a step (c) of joining the second member (36) to the portion of the first member (31) that is to be joined, after the step (b).

In the continuously variable transmission of the disclosure, the first cylinder has the first member that is fixed to the first shaft and the second member that is joined to the outer peripheral portion of the first member. The bearing is interposed between the outer periphery of the first member and the inner periphery of the case. In this way, it is possible to shorten the axial length of the first shaft, compared to when the bearing is interposed between the outer periphery of the first shaft and the inner periphery of the case, on the opposite side of the first member from the first movable sheave in the axial direction of the first shaft. In the manufacturing method of the continuously variable transmission of the disclosure, the first member is formed by the step at least including hot-forging, carburizing processing, quenching processing, and tempering processing, and the second member is formed by press working so that the thickness of the second member is smaller than the thickness of the portion of the first member that is configured to directly abut against the first movable sheave. Cutting is then performed to remove the carburized layer so that the portion of the first member that is to be joined to the second member is exposed. The second member is joined to the portion of the first member that is to be joined. Since cutting is performed to remove the carburized layer so that the portion of the first member that is to be joined to the second member is exposed before joining the second member to the portion of the first member that is to be joined, it is possible to easily join the first member and the second member, compared to when the cutting is not performed. In the continuously variable transmission manufactured in this way, the first cylinder is configured of the first member and the second member. Compared to when the first cylinder is configured of a single member, it is possible to increase the thickness, in the axial direction, of the portion of the first member that is configured to directly abut against the first movable sheave (the portion that is subject to a force from the first movable sheave). Thus, the rigidity of the portion can be increased. It is possible to decrease the thickness (plate thickness) of a portion in which there is not much need to increase the rigidity, such as the second member. It is thus possible to suppress the weight of the second member, the first cylinder, and the continuously variable transmission from increasing. That is, it is possible to increase the rigidity of the portion of the first member of the first cylinder that is subject to the force from the first movable sheave, while suppressing the weight of the continuously variable transmission from increasing. It is possible to shorten the axial length of the first shaft by making the first member directly abuttable against the first movable sheave, compared to when a washer or a sheet member is provided between the first member and the first movable sheave.

The manufacturing method of the continuously variable transmission of the disclosure may further include a step (d) of cutting a portion that needs to be cut besides the portion of the first member that is to be joined and a portion of the second member that needs to be cut, after the step (c). In this case, a sliding contact surface is cut in the step (d) as the portion of the second member (36) that needs to be cut, the sliding contact surface being configured to be in contact with a sealing member (63) disposed on an outer periphery of the first movable sheave (24). In this way, it is possible to suppress variation in the distance between the sliding contact surface of the second member and the shaft center of the first shaft.

The embodiments of the disclosure have been discussed above. However, the disclosure is not limited to the embodiments in any way, and it is a matter of course that the various aspects of the disclosure may be implemented in various modes without departing from the scope of the disclosure.

INDUSTRIAL APPLICABILITY

The disclosure is applicable to the manufacturing industry of continuously variable transmissions.

1. A continuously variable transmission comprising:
a first pulley having a first fixed sheave that is formed integrally with a first shaft or is fixed to the first shaft and a first movable sheave that is supported by the first shaft so as to be slidable in an axial direction of the first shaft;
a first cylinder that forms a first oil chamber with the first movable sheave;
a second pulley having a second fixed sheave that is formed integrally with a second shaft or is fixed to the second shaft and a second movable sheave that is supported by the second shaft so as to be slidable in the axial direction of the second shaft;
a second cylinder that forms a second oil chamber with the second movable sheave; and
a transmission belt that is wound around the first pulley and the second pulley, wherein
the first cylinder has a first member that is fixed to the first shaft and a second member that is joined to an outer peripheral portion of the first member,
a bearing is interposed between an outer periphery of the first member and an inner periphery of a case, and
a thickness of a portion of the first member that is configured to directly abut against the first movable sheave is larger than a thickness of the second member.

2. The continuously variable transmission according to claim 1, wherein
the first member is a hot-forged member, and
the second member is a press molded member.

3. The continuously variable transmission according to claim 1, wherein a carburized layer is formed on at least a surface of the first member that abuts against the first movable sheave.

4. The continuously variable transmission according to claim 3, wherein the carburized layer is not formed on a portion of the first member that is joined to the second member.

5. The continuously variable transmission according to claim 1, wherein
a protruding portion that protrudes radially outward is formed on the outer periphery of the first member,
the second member abuts against an end face of the protruding portion in the axial direction, and
the bearing abuts against the other end face of the protruding portion in the axial direction.

6. The continuously variable transmission according to claim 5, wherein an outer diameter of an inner race of the bearing is longer than a distance between a shaft center of the first shaft and a joining portion of the first member and the second member.

7. The continuously variable transmission according to claim 1, wherein the first member is fixed to the first shaft with a fixing member from an opposite side of the first movable sheave in the axial direction of the first shaft.

8. A manufacturing method of a continuously variable transmission, the continuously variable transmission comprising:
a first pulley having a first fixed sheave that is formed integrally with a first shaft or is fixed to the first shaft and a first movable sheave that is supported by the first shaft so as to be slidable in an axial direction of the first shaft;
a first cylinder that forms a first oil chamber with the first movable sheave;
a second pulley that has a second fixed sheave formed integrally with a second shaft or fixed to the second shaft and a second movable sheave that is supported by the second shaft so as to be slidable in the axial direction of the second shaft;
a second cylinder that forms a second oil chamber with the second movable sheave; and
a transmission belt that is wound around the first pulley and the second pulley, wherein
the first cylinder has a first member that is fixed to the first shaft and a second member that is joined to an outer peripheral portion of the first member,
a bearing is interposed between an outer periphery of the first member and an inner periphery of a case, and
the manufacturing method comprising:
a step (a) of forming the first member by a step at least including hot-forging, carburizing processing, quenching processing, and tempering processing, and forming the second member by press working so that a thickness of the second member is smaller than a thickness of a portion of the first member that is configured to directly abut against the first movable sheave;
a step (b) of performing cutting to remove a carburized layer so that a portion of the first member that is to be joined to the second member is exposed, after the step (a); and
a step (c) of joining the second member to the portion of the first member that is to be joined, after the step (b).

9. The manufacturing method of a continuously variable transmission according to claim 8, wherein the manufacturing method further includes a step (d) of cutting a portion that needs to be cut besides the portion of the first member that is to be joined and cutting a portion of the second member that needs to be cut, after the step (c).

10. The manufacturing method of a continuously variable transmission according to claim 9, wherein a sliding contact surface is cut in the step (d) as the portion of the second member that needs to be cut, the sliding contact surface being configured to be in contact with a sealing member disposed on an outer periphery of the first movable sheave.
